(19) United States
(12) Patent Application Publication
(10) Pub. No.: US 2020/0219140 A1
(43) Pub. Date: Jul. 9, 2020

(54) MESSAGING SYSTEM FOR DELIVERING AUDIO AND/OR VIDEO MESSAGES

(71) Applicant: AdGreetz, Inc., Los Angeles, CA (US)

(72) Inventors: Eric FRANKEL, Los Angeles, CA (US); Evan W. SURDAM, Duarte, CA (US)

(73) Assignee: AdGreetz, Inc., Los Angeles, CA (US)

(21) Appl. No.: 16/734,569

(22) Filed: Jan. 6, 2020

Related U.S. Application Data
(60) Provisional application No. 62/790,274, filed on Jan. 9, 2019.

(51) Int. Cl. G06Q 30/02; G06K 7/14; G06Q 50/00

(52) U.S. Cl. CPC G06Q 30/0271; G06Q 50/01; G06K 7/1417

(57) ABSTRACT

Automated creation of messages, such as, for example, advertising units (“ad units”), based on the audience to which the message is targeted. For example, content of the message may be in relationship to the target audiences' attributes or characteristics as well as the message outlet specifications, and contains relevant targeting/audience attributes, buying strategy and lifecycle on advertising outlets and similar advertising retailers.

### CROSS-REFERENCE TO RELATED APPLICATIONS

This application claims the benefit of U.S. provisional patent application No. 62/790,274, filed on Jan. 9, 2019, which is incorporated by this reference.

### TECHNICAL FIELD

The disclosure relates to messaging systems for delivering audio and/or video messages. In one particular aspect, this disclosure relates to a method and system for the automated creation of online advertising units.

### BACKGROUND

Advertisers (e.g., retailers, brand owners, manufacturers, service providers, resellers) extensively use Internet services (e.g., Facebook™, Twitter™, Google Ads etc.) to market and advertise their brands, products and services to consumers. Billions of dollars are spent annually on such marketing and advertising.

### SUMMARY

Certain challenges currently exist. For example, conventional production of advertising creatives usually involves the individual creation of visual (graphical or video) elements and requires human resources to individually upload and create each advertising unit with associated attributes manually. For more relevant targeting, like the targeting of each state in the United States and/or any personal attribute, a human resource would have to create fifty visual components, fifty different ad units within an ad network, individually upload all fifty creative to their respective units and finally, target each of the fifty units to their corresponding audiences, in this case, state. This has to be accomplished per advertising network/outlet. While this technique may be adequate for a limited amount of ad units, it is not adequate for a large quantity of ad creative.

It is apparent that a need exists for a technique whereby a system can, based on a set of data attributes, such as fifty states, automate the production of advertising creative/units without substantial production efforts and resources. The present disclosure describes systems and methods to automate this process.

This disclosure provides, among other things, a novel system and method for the automated creation of messages (e.g., advertising units or “ad units”) based on the audience to which the message is targeted (e.g., content of the message may be in relationship to the target audiences' attributes or characteristics as well as the message outlet specifications, and contains relevant targeting/audience attributes, buying strategy and lifecycle on advertising outlets and similar advertising retailers, such as Google AdWords). In another aspect, this disclosure is also applicable to the automated process of mass-producing visual elements (graphical or video) that are contained within an ad unit.

Embodiments of this disclosure establish a computer implemented method and system for advertisers to address their marketing and advertising messages about their products and services personally to individual consumers who view websites, including social networks, containing such advertisers' messaging.

In one aspect, there is provided a computer implemented method for advertisers to deliver to recipients personalized messages (e.g., personalized based on a script), wherein user data pertaining to the recipients has been collected via at least one of: (1) recipient input, (2) a social media database containing user input, (3) a CRM database query based on recipient information, (4) cookies and browser header from the recipient net surfing, and (5) second and third-party data providers. The computer implemented method includes a web application server accessing the recipient's user data and storing on a local database; a media server retrieving the user data from the local database, the media server containing a content management system having at least one product template that is defined by the script applicable to multiple products; the media server accessing a media file server containing media clips presenting a product and a position, and processing at least one media clip based on the product template from the content management system and the recipient's user data to generate a personalized message; a content distribution network receiving the personalized message from the media server and relaying the personalized message to the web application server; and wherein the web application server delivers the personalized message to the recipient.

### BRIEF DESCRIPTION OF THE DRAWINGS

FIG. 1 illustrates a system according to an embodiment.

FIG. 2 shows a database schema for an exemplary embodiment.

FIG. 3 is graphical representation of a sample personalized media Product template.

FIG. 4 is an exemplary embodiment of a graphical user interface for a personalized digital product configuration and labeling.

FIG. 5 is a graphical representation of a preferred embodiment database schema for personalized media scheduling, API, product scripts, and user data.

FIG. 6 is a graphical representation of an exemplary embodiment of a strategy scenario schema deployed to a Walled Garden (e.g. Facebook).

FIG. 7 is a graphical representation of an exemplary embodiment of a deployment schema to a Walled Garden (e.g. Facebook).

### DETAILED DESCRIPTION

The disclosure relates to messaging systems for delivering audio and/or video messages. In one particular aspect, this disclosure relates to a method and system for the automated creation of online advertising units. An “advertising unit” contains all necessary creative and data for an ad to be distributed on its corresponding Ad Network, including, but not limited to, ad campaigns, ad groups, ad sets and individual ads. In one embodiment, this disclosure relates to the creation of advertising units in relationship to a targeted audience on a particular Ad Network. For example, the disclosure relates to a method and system for the automated creation of advertising units in relationship to its target audience's attributes or similar audience characteristics. For instance, the disclosure relates to a novel technique for the automated creation of advertising units in relationship to its target audience's attributes or audience characteristics and advertising outlet specifications, and contains relevant targeting/audience attributes, buying strategy and lifecycle on advertising outlets and similar advertising retailers, such as Google AdWords. This disclosure is also further applicable to the automated process of mass-producing visual elements, graphical or video, that are contained within an ad unit.

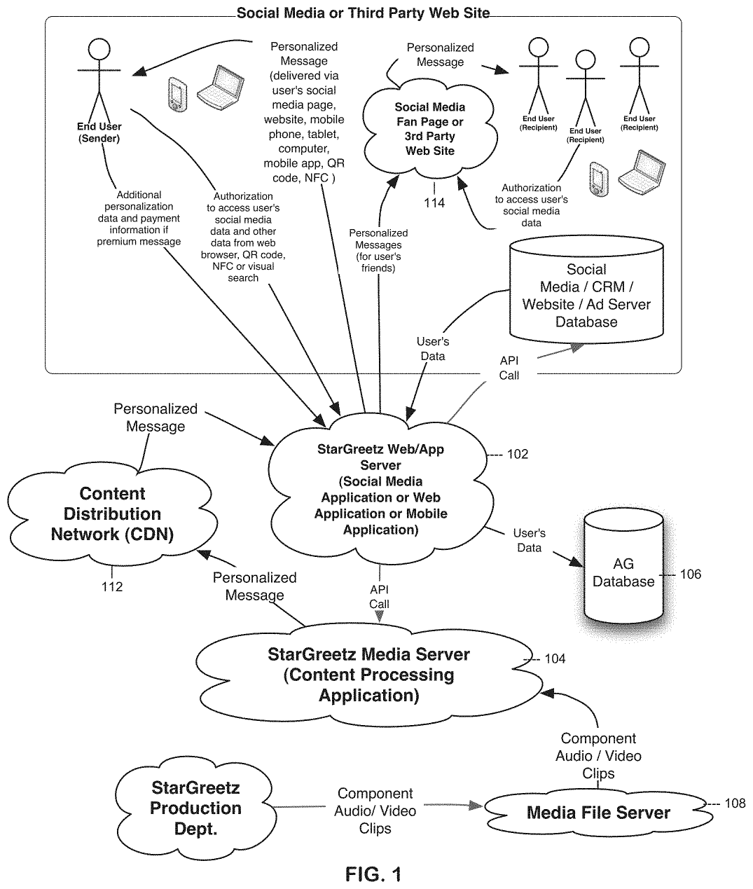

FIG. 1 illustrates a system 100 according to an embodiment. As shown in FIG. 1, system 100 includes, among other components, a social media application 102, a content processing application 104, and a database 106 (referred to herein as the “AG” database). Each of social media application 102 and processing application 104 may reside on one or more application servers (e.g., web servers). That is, applications 102 and 104 may be distributed applications.

Social media application 102 functions to obtain user data pertaining to a recipient and select, based on the obtained user data, a set of one or more audio-video media clips for variable positions (defined below). The user data may include: the recipient's name, data that identifies characteristics of the recipient (e.g., home address, current location, birthday, age, occupation, gender), and/or data that identifies preferences of the recipient (e.g., purchasing habits, web browsing history, stated preferences, likes, dislikes). This user data may be obtained from at least one profile belonging to the user, which profile may be maintained by a third-party service (e.g., Facebook, Google, Twitter, Netflix, Instagram) where users share data about themselves. The user data may also be obtained directly from the user. For instance, social media application 102 may provide an interface (e.g., web page) to allow a user to directly input user data to social media application 102. The social media application 102 then submits a request to content processing application 104 to create one or more personalized messages based on the selected media clips.

Content processing application 104, in response to the request from the social media application 102 for personalized messages, creates or retrieves the requested personalized messages and returns them to the social media application 102 for further processing or distribution. Once the personalized messages have been created, the social media application 102 then delivers them to one or more of the recipients.

Accordingly, in various embodiments, this disclosure contemplates a computer system and a computer implemented method for advertisers to deliver personalized messages based on a script about their products to a recipient, wherein recipient's user data has been collected via at least one of (1) recipient input, (2) a social media database containing user input, (3) a CRM database query based on recipient information, (4) cookies and browser header from the recipient net surfing, (5) second and third-party data providers (e.g., Neilson/Prism), (6) Near Field Communications (NFC) tag, and the like.

### Definitions

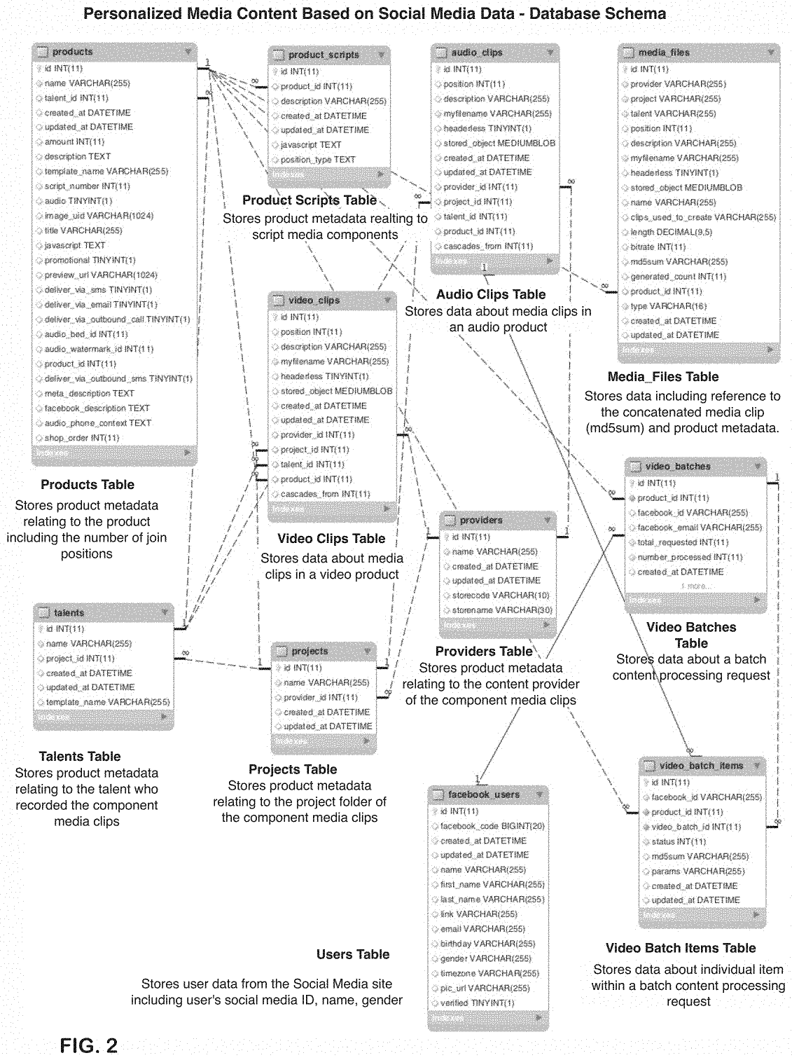

“Product”: a Product consists of two or more “Positions,” which, as described below, comprise one or more media clips. Hence, a Product can be thought of as a collection of digital media clips that can be combined to form personalized digital messages that are transmitted electronically to recipients. To create a personalized message, at least one Position in the Product must be a “variable Position.” Information about Products is stored in the Products table (see FIG. 2) in the AG database 106. A Product is associated with other metadata such as a talent (i.e., an actor, singer, athlete, performer, model, celebrity, etc.) who stars in the media clips and a content provider who provides the talent to the project. The metadata are contained in respective tables in the AG database as shown in FIG. 2.

“Position”: A Position comprises a set of one or more media clips. A Position that comprises a single media clip is considered a static Position (i.e., it is the same for every personalized instance of the Product). A Position that comprises more than one media clip is considered a “variable Position” (i.e., it can differ from one personalized instance of the Product to another). Information about Positions is stored in the Product scripts table (see FIG. 2) in the AG database.

“Media Clip”: A media clip is a digital file containing audio and/or video data that, when combined with other media clips, are used to create a personalized message. Information about media clips is stored in the “audio_clips” and “video_clips” tables in the AG database.

“Personalized Message”: a personalized message is an instance of a Product that has been personalized for a recipient. A personalized message comprises media clips from one or more variable Positions that were selected for the recipient based on user data pertaining to the recipient (as described above social media application may obtain the user data in a variety of ways). The personalized message may also comprise media clips from one or more static Positions of the Product. Information about personalized messages is stored in the “media_files” table in the AG database.

“Script”: Script is the dialog/instructions that will direct and inform the Talent what to say and/or do during a recording session to produce the different Media Clips. The Script identifies the Variable Positions and Static Positions for a Product.

The Social Media Application 102

The social media application 102 preferably resides on one or more application servers (e.g., web servers or other servers) and is responsible for obtaining user data pertaining to a user for the purpose of determining the selection of media clips for variable Positions. This user data may be obtained from the recipient's profile on the third-party sites (e.g., third-party social media sites) where users share data about themselves and/or through direct user input to the social media application 102. The social media application 102 then submits a request to content processing application 104 to create one or more personalized messages based on the selected media clips. Once the personalized messages have been created, the social media application 102 then delivers them to one or more recipients.

The social media application 102 in the preferred embodiment supports one or more of the following functionalities.

[1] Sending a Personalized Message to One User (Including Self).

Social media application 102 has the ability to select and personalize a given Product for a recipient; and to preview, purchase, and send a personalized message from a sender to a recipient. In one embodiment, the recipient is registered with a third-party site (e.g., Facebook™); the recipient is logged into a third-party site (e.g., Instagram); the media clips for all of the Positions for the given Product are stored on and available from the media file server 108 (see FIG. 1). The social media application 102 is configured (e.g., coded) to obtain information on the given Products from the AG database.

The social media application 102 is coded to obtain from the AG database a list of the Positions for the given Product, and, for each Position, a list of the available media clips with which the Position is associated. As described above, each Position is associated with one or more media clips. For example, the given Product includes a Position representing the message recipient's name and social media application 102 obtains the list of available media clips for this Position. The list of available media clips for the Position representing the message recipient's name may include: a first media clip of talent saying the name “Abby,” a second media clip of talent saying the name “Adam,” a third media clip of talent saying the name “Alice,” and so on. The recipient grants the social media application 102 permissions to access the recipient's user data from the third-party website.

In some embodiments, for user data that is maintained by a third-party, social media application 102 obtains the user data via an API call to the third-party's website (i.e., HTTP server) and stores the obtained user data in the AG database in the Users table (e.g., Facebook_Users table in the database schema, as in FIG. 2). As noted above, this user data may include the recipient's name, gender, location, birthday, online handle, interests, affiliations, etc. The interests may include hobbies, sports, foods, movies, games, music genres or bands, books, etc. The affiliations may include family members and extended relatives; fan clubs; school alumni; business associations; sports teams; commercial brands of clothing, vehicles, cosmetics, consumer Products; popular following of entertainers, celebrities, artists, pop stars, sport stars; etc.

In one embodiment, social media application 102 may display a user interface to a recipient, and the recipient may select a Product that is displayed in the user interface. The social media application 102 uses the recipient's user data (e.g., obtained from a third-party) to determine the selection of the media clips for one or more of the variable Positions of the selected Product. The social media application 102 may also use data obtained through direct user input to the social media application 102 to determine the selection of the media clips for certain variable Positions.

The IDs of the selected media clips for each Position of the selected Product are passed via API call as a request to content processing application 104 to create the personalized message. Content processing application 104 integrates the recipient's user data with the media clips to generate the personalized message, and places the generated personalized message on a content delivery network (CDN) 112 (a.k.a., content distribution network (CDN)), and optionally returns to the social media application 102 a reference to the generated personalized message. Further details regarding content processing application 104 are provided in the following section. The recipient can then use a media player in the social media application 102 to play the personalized message.

Alternatively, if the Product has been designated as premium (paid) content, the recipient pays for the content in the social media application 102 interface by providing his or her payment credentials (e.g., PayPal™, Google Wallet™, credit card, etc., or credits that have value on the third-party website). The user can also electronically send the personalized message to his page on the third-party website, or to a friend's page.

[2] Sending a Personalized Message to Many Recipients

In this option, the algorithm is the same as sending a personalize message to one user described above, but instead of one by one, requests for personalized messages from a sender/recipient to multiple recipients are submitted as a batch (video_batch table in the AG database) and placed by the social media application 102 into a queue. Each item in the queue is referenced by unique ID in the video_batch_items table of the AG database.

Each request in the queue to create the personalized message is sent to content processing application 104. Content processing application 104 creates the personalized message for each recipient and stores it on the content distribution network.

The social media application 102 may monitor the queue to let the user know what percentage of request for the user's batch is completed. When all of the requests have been completed by content processing application 104, the social media application 102 posts the personalized messages to each recipient's page on the third-party site and notifies the sending user that their batch of requests has been completed. Alternatively, the personalized messages may be posted to each recipient's page as soon as the message has been completed (e.g., rather than waiting until all messages are complete). Further, the requesting sender may be provided with the option of when to receive notifications (e.g., during processing on a per personalized message completion versus when all personalized messages are complete) and when to post personalized messages to recipient's web pages.

[3] Play a Personalized Message on a Recipient's Social Media Page, Social Media Fan Page, Social Media Wall or News Feed or Third-Party Website Via Button Click

This embodiment allows the ability to place a specifically formatted post on a page of a third-party site and have that post play a personalized message on the third-party site which can be shared with other members of the site.

Preconditions include the following: the recipient is registered with a third-party site (e.g., Facebook™). The recipient is logged into a third-party site (e.g., Facebook™). Media clips for all of the Positions for a given Product are stored on and available from the media file server. The social media application 102 is coded to obtain information on one or more Products from the AG database. The social media application 102 is coded to obtain a list of the Positions for each Product, and a list of the media clips for each Position from the AG database. For example, a list of available media clips for the Position representing the message recipient's name may include Abby, Adam, Alice, and so on. A specifically formatted post is placed on a page on a third-party site. Embedded in this post are links to the social media application 102 and references to a specific Product.

In use, the recipient clicks on the specifically formatted post. The recipient is asked to grant permission to the social media application 102 to access the user's social media data from the third-party site. The recipient grants the social media application 102 permission to access the recipient's user data from the third-party site.

The social media application 102 obtains the recipient's social media data from third-party media site database via API call to the third-party website and stores it in the AG database, in the Users table (e.g., Facebook_Users table in the database schema, FIG. 2). This data may include the user's name, gender, location, etc.

The social media application 102 uses the data obtained from the third-party website to determine the selection of the media clips for one or more of the variable Positions of the Product referenced by the specifically formatted post. The IDs of the selected media clips for each Position of the referenced Product are passed via API call as a request to content processing application 104 to create the personalized message. Content processing application 104 creates the personalized message and places it on the content distribution network, and optionally returns a reference to it to the social media application 102. The user can then play the personalized message using a media player embedded in the specifically formatted post on the third-party website. The recipient may optionally send the personalized message to his or her page on the third-party website, or to a friend's web page.

[4] Play a Personalized Message on a Third-Party Site (e.g., User's Social Media Page, Social Media Fan Page, Social Media Wall or News Feed Via Instant Personalization

This embodiment provides the ability to place a specifically formatted post on a page of a third-party site and have that post play a personalized message on the third-party site which can be shared with other members of the site.

Preconditions for this embodiment include: the recipient is registered with the third-party site (e.g., Facebook™). The recipient is logged into a third-party site (e.g., Facebook™). The media clips for all of the Positions for a given Product are stored on and available from the media file server. The social media application 102 is coded to obtain information on one or more Products from the AG database. The social media application 102 is coded to obtain a list of the Positions for each Product, and a list of the media clips for each Position from the AG database. A specifically formatted post is placed on a page on a third-party site. Embedded in this post are links to the social media application 102 and references to a specific Product. The host site (where the recipient receives media) has an agreement with third-party site that allows it to authenticate visitors to the host site who are registered with and logged into third-party site.

In use, the recipient clicks on the specifically formatted post. The algorithm in this alternative embodiment is the same flow as in embodiment [3] above, except the recipient does not have to grant permission to the social media application 102 to access the recipient's data from the third-party site since this permission has already been granted through the “Instant Personalization” agreement between the host site and the third-party site.

Content Processing Application 104

In one embodiment, content processing application 104 resides on one or more servers. Content processing application 104 receives requests from social media application 102 for personalized messages. It creates or retrieves the requested personalized messages and returns them to social media application 102.

In one embodiment, a request for a personalized message comprises a list of media clips (that is, a set of media clip IDs each of which identifies a media clip), the Position to which each media clip belongs, and the Product to which the requested personalized message belongs. Content processing application 104 determines whether the personalized message has already been created.

For example, in one embodiment, content processing application 104 calculates the MD5sum for the requested personalized message and queries the AG database to see if that MD5sum exists in the media_files table. If it does, this personalized message has already been created and stored on the content distribution network. The MD5sum is a unique identifier for the personalized message based on MD5 (a Message-Digest algorithm—a cryptographic hash function with a 128-bit hash value).

If content processing application 104 determines that the personalized message has already been created, then content processing application 104 simply returns a reference to the location of the personalized message on the CDN 112 to social media application 102.

If, on the other hand, content processing application 104 determines that the personalized message has not yet been created, then content processing application 104 creates the personalized message. First, it retrieves each of the media clips, either from a locally cached copy on the media server, or, if a clip is not in the local cache, from the media file server. The media clips are then combined (e.g., concatenated) to create the personalized message. The process used to combine the clips for audio only Products is different from the process used to combine video Products. These processes are described in greater detail below. Once the personalized message has been created, it is stored on CDN 112, and information about it (including its MD5sum or checksum) is stored in the media_files table of the AG database.

Below is exemplary code for content processing for audio.

Self.clips_used_to_create.split(“,”).each do |f|

begin

if (product.audio watermark.present? and product.audio_watermark.id == f.to_i)

or (product.audio_bed.present? and product.audio_bed.id == f.to_i) then

Nil

Else

tf.print(AudioClipRedis.grab(f).stored_object)

End

```
  Rescue
  End
```

End
tf .close( )
system(“sox −cl −r 48000 −t raw −L −s −2 #{tf.path} −t wav #{tf.path}.wav”)
if product.audio_bed.present? then

Tf2=Tempfile.new(‘ab_encoding’, tmpdir=‘/dev/shm’) //use tmpfs filesystem. no disk i/o
Tf2.print(product.audio_bed.stored_object)
Tf2. close ( )
system(“sox −cl −r 48000 −t raw −L −s −2 #{tf2.path} −t wav #{tf2.path}.wav”)
system(“sox −M #{tf2.path}.wav ‘ | sox #{tf.path}.wav −p pad 0’ −c 1 −r 48000

```
  #{tf .path}.2.wav trim 0 ‘soxi −D #{tf .path} .wav’ && mv #{tf.path}.2.wav
  #{tf.path}.wav”)
```

End
def transcode(tempFile, quality)

if quality then

system(“export TERM=vt100; lame −m m −r #{quality.settings} −S #{tempFile}.raw

#{tempFile}.mp3”)

Else

system(“export TERM=vt100; lame −m m −r −s 48000 −b 40 −S #{tempFile}.raw

#{tempFile}.mp3”)

End

End

The component media clips for an audio Product may be stored on the media file server in “way” format. The component media clips are concatenated by “printing” them sequentially to a stored object file (lines 26-37).

Header meta-data files are re-indexed, and an optional audio bed may be added using SoX (Sound exchange) encoder under the GPL license (lines 38-45 above).

The file may then be transcoded to mp3 (Motion Picture Experts Group Audio Layer 3) format using any type of mp3 encoder (e.g., the LAME™ mp3 encoder (lines 110-116 above)). Alternatively, other formats/types of media content files can be used (e.g., AVI, WMV, etc.).

The resulting personalized message (in this case, a personalized audio file (.mp3 file)) is stored on the CDN 112 and a reference to the personalized audio file is stored in the media_files table of the AG database, in the MD5sum field (or other identification field such as a checksum). The MD5sum is a unique identifier to the processed media file.

Below is exemplary embodiment code for content processing for video.

#Split Files
Clip_ids.each do | clip_id |

system(“export TERM=vt100; cd #{working_dir}; MP4Box −raw 1 #{clip id}.mp4; MP4Box −raw 2

#{clip id}.mp4;”)

End
video_merge = clip_ids.map{ |x| “#{x}_track1.h264”} * “ ”
audio_merge = clip_ids.map{ |x|“#{x}_track2.aac” }* “ ”
#Concatenate Files
system(“export TERM=vt100; cd #{working dir};

```
  cat #{video_merge} > concatenated_video.h264;
  cat #{audio_merge} > concatenated_audio.aac”)
```

#Merge Audio/Video
system(“export TERM=vt100;

cd #{working_dir}; MP4Box −add
\“concatenated video.h264:fps=24.2\” −add
\“concatenated audio.aac\” af_encoding.mp4”)

The component clips for a video Product are stored on the media file server as H.264 encoded video and AAC encoded audio in an .mp4 container. Alternatively, the component clips may be stored and/or encoded in any other type of format (e.g., MOV).

First, for each component video clip, the clip is split into a video file and an audio file (lines 67-70 above). Next, a string is created that references the video files and another string that references the audio files (lines 71-74 above). Next, the video files and the audio files are separately concatenated (lines 75-76 above).

Finally, a new stored object is created composed of the concatenated video files and concatenated audio files in an .mp4 container (or other format), using a multiplexer (e.g., MP4Box™) (lines 78-79). The concatenated file is stored on the CDN and a reference to it is stored in the media_files table of the AG database, in the MD5sum field. The MD5sum is a unique identifier for the personalized message, based on the MD5 hashing algorithm.

### Additional Embodiments

In one embodiment, there is provided a computer system and computer implemented method for advertisers to deliver personalized messages based on a script to a recipient, wherein user data pertaining to the recipient has been collected via at least one of: (1) direct input from the recipient, (2) a third-party database containing user data pertaining to the recipient, (3) a CRM database query based on recipient information, (4) cookies and browser header from the recipient's net surfing, and (5) second and third-party data providers.

The computer implemented method includes: (1) a first server (e.g., a web application server) accessing the user data for the recipient and storing the user data in a local database; (2) a second server (e.g., media server) retrieving the recipient's user data from the local database, the second server contains a content management system storing at least one Product template containing a script, which Product template can be used to create multiple personalized messages; (3) the second server accessing a third server (e.g., media file server) containing media clips, each media clip being associated with at least one Position of the Product template; (4) the second server processing at least one media clip based on the Product template and the recipient's user data to generate a personalized message for the user; (5) a content distribution network receiving the personalized message from the second server and relaying the personalized message to the first server (e.g., web application server); and (6) the web application server delivers the personalized message to the recipient.

(1) Scripting—Creation and Physical Production of a Script in Accordance with Pre-Defined Template to Enable Efficient Integration with a Content Management System to Produce/Create Personalized Message (i.e., Media/Audio-Video Content).

(1.1) Overview

The script is designed in a manner such that media clips for different Positions can be created for input into a Content Management System (CMS). Scripts can be used for audio and/or video Products.

(1.2) Scripting Process

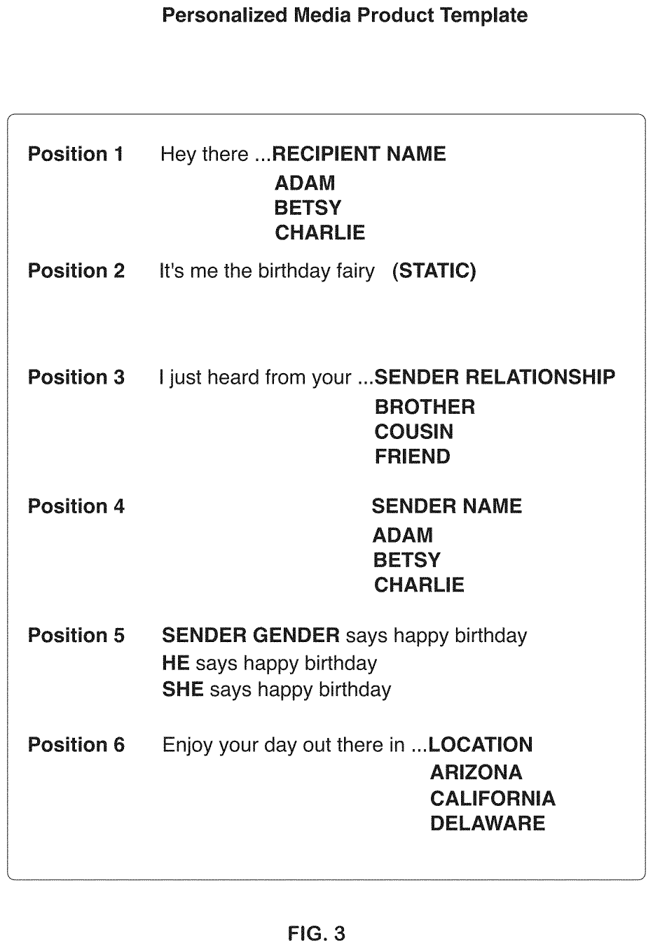

FIG. 3 illustrates a Product template containing a script. A writer authors the script and specifies various Positions. In the example shown, six different Positions are specified (Position 1 through Position 6). Each Position is associated with a portion of the script. A director who supervises the asset recording process follows the script to make sure that the assets are recorded and filmed (in the case of video), so that they can be edited into media clips and the media clips associated with the correct Position. In one embodiment, when the recording or filming session is complete, raw assets are generated and media clips can be generated from the raw assets. For example, a media clip of a talent (e.g., an actor or celebrity) saying the line: “Hey there Adam” will be created and associated with Position 1 of the template. Likewise, a media clip of the talent saying the line: “Hey there Adam” will be created and associated with Position 1 of the template

In one embodiment, there is one raw file for each Position. For example, with respect to Position 1 shown in FIG. 3, there will be a raw file (e.g., a single media file) with names A thru Z recorded (e.g., Adam, Andrea, . . . Xander). A creative manager gives an editor direction on editing a raw asset into multiple media clips. An editor cuts the raw assets into variable and static media clips. The editor responds by uploading actual files to a shared drive on the network. If video, editors provide two video file formats, compressed files for loading into the CMS and uncompressed files for previewing and performing quality assurance prior to loading. Sometimes variable Positions (e.g., Position 1) impact other Positions in the script (e.g., if variable Position 1 is vehicle, the options may include “car” or “boat”; and options for variable Position 3 distinguish the vehicle's color, such as “blue” or “red”, then based upon the users selections, the finished Product would denote a “blue car” or “blue boat”). In this example, the variable options in Position 3, will be limited to the options pertaining to the selected option in variable 1.

(1.3) Template Definition and Editing Process

A Product may have a specified template (an example is shown in FIG. 3), that contains a script. The template contains all pertinent information and is divided according to the various Products that form the script in its entirety. The following are a list of possible Product templates:

| Template | Description |
|---|---|
| Ringtone | Personalized audio or video file that can be set |
| | as ringing sound or movie played when mobile |
| | phone or tablet device is called. |
| Ringback | Personalized audio or video file that can be set |
| | as sound to entertain callers who call a user's |
| | mobile device, tablet, or computer. These are set |
| | by the connection provider, e.g., mobile carrier. |
| Audio Greeting | Personalized audio message made by a sender to be |
| | played by a recipient |
| Mobile Alert | Personalized audio or video file that can be set |
| | as phone sound or movie played when mobile phone |
| | or tablet device receives a new message or other |
| | system notification. |
| eCard | Personalized video message made by a sender to be |
| | played by a recipient. |
| eInvitation | Personalized audio or video message made by an |
| | event host to be played by one or more event guests. |
| Social Media | Personalized audio or video message delivered to |
| Broadcast | members of a social network via push notification |
| Message | message when then user is logged into the social |
| | network site, e.g., Facebook ™ newsfeed. |
| Social Media Page | Personalized audio or video message delivered to |
| Welcome Message | visitors of a social media page or website that |
| | allows a user to authenticate and allow a social |
| | media app. Welcomes the user to the page by |
| | personally greeting him. |
| CRM message | Personalized audio or video message that is pre- |
| | generated or generated at the time of user pick |
| | up based on input variables imported and matched |
| | to variables in Product Positions |

In one embodiment, the template is configured to ensure that when media clips are concatenated together to form a personalized message the personalized message will have a pre-defined duration (e.g., 30 seconds). For example, each variable within the Positions will fit together exactly when concatenated together in the personalized message and to ensure that there are no lapses in concatenated versions of the personalized message. Accordingly, the template may provide a structured timeline that indicates the total duration of the personalized message and duration of each Position contained within the template. For example, a Position may have individual media clips with a running time of 10 seconds—each variable within said Position must have a running time of 10 seconds.

The Product template can be created in any media editing software (e.g., for video Apple Final Cut Pro). A master Product is created using the template and contains one media clip for each Position. This serves as a reference for the editing process. Generally, names are at the beginning, so as to allow for extension of the Products length at one end, rather than disrupting the mechanisms that govern the core central portion of the Product. Variable Positions may differ in length (i.e., 5 or 10 seconds), however media clips within a Position will be uniform in length. Scripts are modified before filming to try and make sure it fits into master. The timeline is built as an average of different variables in the various Positions and variables are shortened or expanded to fit the timeline, in the editing process.

Additionally, the template determines which media clips may be used in multiple locations for various Products. For example, the color variable may be utilized in an eCard as Position 3, however, the same media clip may serve as Position 2 in a Facebook™ poke. Utilizing media clips in numerous Products allows Production to be more efficient in the recording process.

In the event that editors are unable to create media clips of identical lengths for a particular Position, a second master may be generated, as well as files for all subsequent Positions. For example, in a Product template comprised of 13 Positions, if several variables contained within Position 7 exceed the lengths of the other variables within Position 7, editors will need to generate differing media clips for at least one of Positions 8-13, which would coordinate with the second master. Though, the files may be identical to the first master, music cues or other visual effects may need to be adjusted to accommodate the discrepancies in Position 7.

As an example, assume that a Product has two positions (Position 1 and Position 2). Position 1 is a variable position and Position 2 is a static position. It is possible that not all of the media clips for Position 1 will have the same duration. For instance, a first media clip for Position 1 may have a duration of 10 seconds while a second media clip for Position 2 may have a duration of 12 seconds. If the personalized messages based on the Product must have a fixed duration (e.g., 30 seconds), then in this scenario two different versions of the static media clip for Position 2 need to be created—i.e., a 20 second version and an 18 second version. This enables the system to create a 30 second personalized message regardless of whether the first or second media clip is selected to occupy position 1 of the personalized message. That is, if, based on the user data, the first media clip is selected to occupy position 1 of the personalized message, then the system will automatically concatenate the first media clip (duration 10 seconds) with the 20 second version of the static media clip, thereby producing a first 30 second personalized message based on the user data. Whereas, if, based on the user data, the second media clip is selected to occupy position 1 of the personalized message, then the system will automatically concatenate the second media clip (duration 12 seconds) with the 18 second version of the static media clip, thereby producing a different 30 second personalized message based on the user data.

Name field in Products Table is the “Product Type.” Business logic in application controller determines what specific Position order must be enforced for a specific template. For example, an eCard contains both a Sender Name and a Recipient Name.

(2) Personalized Digital Product Configuration and Labeling Process

(2.1) Asset Naming/Labeling

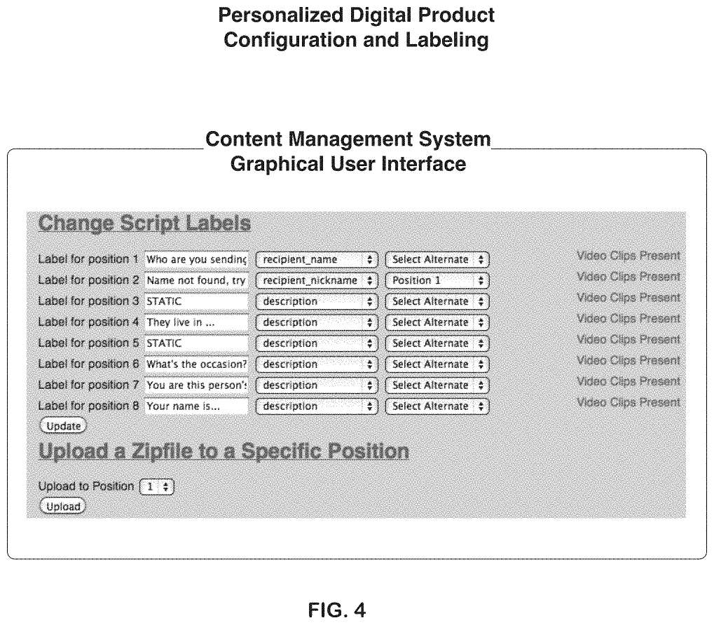

The template also establishes the naming conventions used for files, depicted graphically in FIG. 4. Taking into account the advertisers experience (media clip file names are what the recipient sees when generating a Product), Products are named in a manner that simplifies the process. For example, if the Product asks for the advertisers to indicate the color of their vehicle, files may be called “blue,” “red,” or “black.” For static Positions, files are named “static_01,” which would indicate the file is the first static Position.

Variable Position media clips may be duplicated for different variations of variable Position. For example, name homonyms may be generated from an existing raw asset (e.g., Eric, Erik, Eryk). This enables Production to record only one variation of the name, thus curbing the length of time of the Production shoot. For example, if a media clip contains a recording of the talent reading out loud the phrase “Good Morning, Eric,” this this media clip will not only be linked to the name “Eric,” but also to the names “Erik” and “Eryk.” Hence, if the system obtains user data indicating that the user's name is “Eryk,” the system may create a personalized message for Eryk by concatenating the media clip containing the recording of the talent uttering the phrase “Good Morning, Eric” with one or more of media clips.

(2.2) Map/Tag Position Clip Asset to Specific Product

Once the assets have been edited, labeled/named, and verified for quality assurance, the assets are then loaded/mapped to specific Products within the Content Management System (CMS), again shown in FIG. 4. Every Product is created in the CMS. The Positions of the Product are then mapped. For each Position, specific language in the template, often in the form of questions, determined what markers advertisers will see to aid in selection of variables within a Position (i.e., what color is your car?). Once the Product has been mapped and created, the files are uploaded into the CMS.

(2.3) Map and Tag Product to Specific Delivery Mechanism/Storefront/Category

Once the Products have been created in the CMS, assets loaded in each individual Position, and passed through a rigorous final round of quality assurance, sample Products are generated for advertisers to get a quick view of the Product in its entirety. Only then are the Products ready to be tagged for the numerous forms of distribution (e.g., storefront, talent fan page, talent Facebook™ page, etc.).

Tags are concise words that prompt appearance of Products in specific locations for distribution or sale. Tags are specific to Products and not Positions. For example, a birthday.

eCard would be broadly marketed across numerous distribution channels and tagged accordingly. Tags such as “storefront,” “fanpage,” “iPhone,” “Android,” “birthday,” “eCard,” etc., would determine where the Product would be available for distribution, viewing or sale to users. Examples include applying the tag “storefront” makes the Product appear on the AdGreetz's shop. The tag “iPhone” makes it appear in the AdGreetz iPhone app and the tag “birthday” makes it appear in the birthday sections of all storefronts. Individual tags may direct mapping to multiple distribution channels (e.g., “eCard” will allow for eCards to be distributed on various storefronts). If a Product contains the tags “storefront” “iPhone” and “birthday,” it appears in the birthday section of both shop and iPhone.

Tags may also be dependent upon one another. For example, in order for a Product to appear in the storefront under a particular category, such as Holidays, the Product must be tagged “storefront” in addition to “Christmas.” Without the “storefront” tag, the Product will not be seen by users browsing the Product offerings under holidays.

(3) Graphical User Interface Design for Specific Personalized Message

(3.1) Personalized Message Specific Script Label Creation

Determine text to be displayed to user specific to a particular personalized message (e.g., wake-up call, website message, etc.).

Product specific. Each Product has Positions. Some are variable and some are static. The variable Positions have script labels that describe the Position, e.g., “What occasion are you celebrating?” and variable names, e.g., “bar mitzvah, graduation . . . .”

Text examples: “where do you live?” or “what is your favorite Reba song?”

This text defines the GUI presentation for a particular personalized message. These are script labels for a variable Position.

(3.2) Map Text to a Specific Variable Position Name

Providing a script variable name that corresponds to each potential variable Position the value for the variable has the different options/selections that are permissible, e.g., drop down list has all the states listed or names or hobbies, etc.

Alternatively, provide a label name (i.e., identify the variable name that will be used to store the variable Position value) to be received by the CMS so that third parties can make their own interface via an API Personalized Message Specific Script Label Creation may limit user input based on prior responses (“Cascading”) certain variable selections cascade from one to another. Occasion for card, e.g., happy b-day, at end of card, it will repeat, happy b-day from your friend.

In other words, do not ask user same question twice. The answer provided by user will cascade down. Once all the selections have been made by the user (or received from a third-party via an API), the next task is to match the selections to the appropriate Positions in order create the concatenated personalized message that will be delivered.

“Description” in the Products Scripts table is where the label name is stored. “Position Type” in the Products Scripts table contains semantic meaning of what type of Position it is and application can perform business logic to validate the fields and construct the user interface accordingly. Some examples include:

(1) Name - Usually the largest number of values as these are values for
possible user first or last names.
(2) Static - Position with only one media clip and no variables.
(3) Gender - Male, Female or Gender Neutral default.
(4) Cascades From - Assigned from another Position such as if a user's
name is said more than once in script.
(5) System Defined - Selected based on system values such as time or
location triggers, e.g., “Sale starts in 3 days, 2 days, or Today”
based on countdown.

(4) Personalized Video and Audio Content Based on User Configured, System Configured, and Hybrid Configured Information

Precondition: Loading a Product that can be personalized, and all the associated clips used to create it, into the CMS as described in Scripting and Product Configuration processed above.

(4.1) User Configured Data

Information based on event initiated by the user. A user goes to a website, microsite, iFrame, widget, mobile device app, or mobile site where a Product is offered for personalization and pulls down options from a drop down menu, enters text into input boxes, checks radio buttons, sliders, check boxes or other interface elements to select variables for each variable Position in the Product. Once selections have been completed, the user selects a submit button.

(4.2) System Configured Data

Information based on knowledge base maintained or accumulated by CMS. Examples include date, time, weather, news, etc.

(4.3) CRM (Customer Relationship Management) personalized message.

Strategy for managing a company's interactions with customers, clients and sales prospects. CMS pulls up time and location data, weather and date and matches it to variable Positions in the AG database and provides input to matching process. The personalized CRM message is generated by a script run on a server where the trigger could be time based. Hybrid Configured Information can also be taken as an input to the process

(4.4) QR Code

Quick Response (QR) code—specific matrix barcode (or 2D code) readable by dedicated QR barcode readers and camera phones. QR codes when scanned by an iPhone, smartphone, tablet, or like mobile device or reader, provide typically a link to a website, and can store text, email addresses, telephone numbers, etc. It is contemplated to embed personalization data into QR codes (or bar codes). The QR code is a CRM Product as well as an activation Product could include personalization variables such as name, location (off of browser—e.g., “Macy's store #13”), time, etc., into the QR code. The QR code can launch onto a web browser and have user input data such as wife's name and then use combination as a trigger to provide personalization. For instance, a male user going to a retail store, e.g., Macy's, with girlfriend, that user scans one QR code and gets one response for men's blazers, while girlfriend scans same QR code and gets a second response for women's skirts.

(4.5) Social Media or Third-Party Site

Triggered by allowing a social media app, e.g., a Facebook™ app. Social media site acts as a proxy to serve applicant AdGreetz API personalization data that sends back personalized message, message plays in player in social media app. Can live outside of social media site on a site that allows users to authenticate via social media site.

(4.6) Check-In

User checks into Starbucks® Coffee Shop, e.g., via Foursquare (www.foursquare.com). Foursquare tells an AdGreetz server that they checked in someplace. The server matches userid and check-in and sends message to user—e.g., “Welcome to Starbucks® on corner of Olympic Avenue and Bundy Avenue in Los Angeles.”

(5) Delivery of Personalized Media Content

Distribution mechanisms for personalized messages, including: Outbound call—Personalized audio message delivered by telephone call or Voice Over IP (VoIP) call; social media application 102s (e.g., Facebook™, YouTube™, Foursquare, Twitter™, etc.); website or microsite; mobile website; email; mobile device apps, e.g., Android, iPhone, Java; electronic billboard and other digital signage content management system that manages display ads; and Quick Response (QR) Code.

(6) Personalized Message Playback with Automatic File Resolution Determination and Use

Content processing application 104 encodes media clips to produce multiple formats of a personalized message that is multi-platform compatible and optimized. Multiple video qualities are supported for the personalized message including: Hi Definition—If opened on a high-def TV; Mobile—If opened on a phone, get a file that works on that medium; Computer—If opened on a laptop, desktop, or tablet computer.

The personalized message is wrapped in a URL that, when clicked, detects the web browser of the device that it is opened on. Based on device information, an API call is triggered that matches the appropriate quality with the target device.

Video Clips and Audio Clips table contain a field named Quality with possible values High, Medium, and Low representing the bit rate and resolution for video or audio encoding. The resulting three quality levels of the media clips are stored in the respective video clips or audio clips table.

(7) Server Interaction to Generate Personalized Message for Viewing in Thin Client Device

Mobile Apps may serve as a distribution mechanism, e.g., iPhone, Android, Microsoft Windows Smartphone, Java. Applications are mobile interface for the personalization platform. This is the same interaction as on website but looking at it through a mobile device app interface. Personalization works the same as on website and on mobile with no quality degradation.

Creation and Display of Personalized Message on a thin client device may involve interaction with multiple different servers. Able to take API and through different parts of interface, interact with different servers and then preview personalized content.

(7.1) Overall Process of Personalization Delivery

App hits various servers for info and gets personalized message. Content processing application 104 produces a personalized message. Media files are loaded into the Media File Server Product metadata is loaded into the Database Server. Web/Application Server contains software to present UI to user to personalize product and serves request for personalization to the Media Server. The Media Server then pulls clips from media file server, on request from the Web/Application Server and produces a personalized media file which is served to the user interface (or API) by the Web/Application Server.

(8) Web iFrame and Widget Use to Generate Personalized Message

One alternative embodiment includes the ability to provide a user interface for personalization to utilize the same process regardless of location, e.g., personalized and buy from partner's website, from AdGreetz website, etc., all via AG API. Examples include web iFrame which allows a web developer to include content from external sources inside a web page, or a graphical user interface (GUI) widget. This allows the ability to layer onto other websites, including the ability to order, preview, and purchase products using the system described herein although not through the website 102. Variable matching and personalization preferably happen via AG API.

A script library, such as javascript or actionscript, may be provided for a web developer to implement on a website. The library contains calls to the AG API to provide data inputs for personalization and output an iFrame URL that contains the personalized media. This iFrame can reside on a website, a mobile website, a microsite, inside a social media application 102 such as a Facebook™ application tab.

(9) Delivery and Pick-Up of Personalized Message at Designated Location

In another embodiment the system provides the ability for a recipient to retrieve a personalized message personalized for the recipient by a sender. Sender picks x variables and configures personalization options for recipient that includes unique identifiers such as email, phone number, name, gender and location. Options are used to make a personalized media clip when executed by Content processing application 104. Recipient provides system with one or more identifiers and gets a match from the AG database. The recipient may need to enter the code/identifier in the interface to retrieve the personalized message made for him. System executes the stream and user views or listens to his personalized message.

When a sender personalizes a message for a recipient, via input of variables into a user interface, the interface makes API calls to the AG database to retrieve options for the Product script. Sender's inputs are sent to the AG database via API call and system creates an envelope in the AG database.

Envelopes Table contains an “Envelope ID” for each recipient of a personalized message. The “Status” field in the Envelopes Table indicate whether the recipient has picked up their message or not.

This same method can be used within the system as a batch process for a CRM database data based blast send of a personalized message for each recipient on a mailing Customer's CRM system sends the AG API a Customer ID and personalization data parameters (e.g., name, age, shopping history, etc.) for each recipient of a Product, AG API returns a pickup link to media that Customer can send via Twitter™, Facebook™, email, telephone, QR code, Near Field Communication (NFC), website, mobile device, or any other delivery mechanism.

The link format is as follows: www.URL.com/token.

Where the URL is the URL where the web application resides, and token is the unique identifier for personalized media (MD5sum). The AG API can be accessed in a transactional manner or a batch manner accepting inputs and returning outputs in format of comma or delimited text files, XML or JSON.

(10) Recurring Nature of Personalized Message and Scheduling

In another embodiment the system provides the ability to schedule a recurring personalized message that is delivered at specified times or intervals via a user interface that makes API calls to the AG database. Some examples include: Personalized daily wake up calls—personalized each day differently (e.g., with day of week/weather); Personalized Updates and Alerts based on new information such as time, weather, or other automatically generated/retrieved data.

(10.1) Implementation

Inside concatenated message there is an end card that is swapped out based on date or other info leading up to the end card, e.g., a countdown that is triggered by date, “new episode starts on April 8; new episode starts on Friday; new episode starting tonight.” Web application gets scheduling information from AG database to rotate out media clips in certain Positions within a message based on time or user upload, e.g., “All new lease offers for Toyota® Prius™ only for May.”

Delayed Job Table contains personalized media delivery scheduling information such as “Product ID,” time, and personalization parameters for each recipient of the messages.

Workflow in application determines variables with time or geographical triggers, e.g., day of the week determined by system clock or user location will be used to personalize the scheduled message for the user.

(11) Sponsored Message Delivery of Personalized Message or Sponsored Position within a Personalized Message

A personalized message that is free to the recipient but is paid for by a promotional sponsor who inserts one or more promotional media clips into Product Positions via CMS. For example, if instead of a user purchasing an eCard for $2.99, he personalizes it for free but the last Position in the eCard says, for instance, “This message is brought to you by Redbull®,” or “Congrats on your recent engagement, sponsored by Bridal Magazine®.”

(11.1) Configuration of the Promotional Positions in CMS

Sponsored message content is recorded, filmed and uploaded to the CMS according to the processes described above. This content may represent one or more media clips in one or more Product Positions within a message. The promotional Positions are combined with the other Positions to produce one seamless personalized message for the user.

(11.2) Delivery of the Personalized Message Containing Promotional Positions

Advertisement used is based on personalized info that is catalogued in a database. Content processing application 104 produces a personalized message per process described above that is delivered to the user via the delivery methods described above.

(12) Application Programming Interface (API) for Creating and Delivering Personalized Messages

An Application Programming Interface (API) provides methods for a software developer to use the following system functionality in their applications to deliver personalized messages:

(1) “Introspect” data objects including Products, Positions, tags, variables.
Product metadata, Products Table in the database.
(2) “Script and Template” their own Products and persist these Products to
the AG database in the Products Table.
(3) “Configure User Interfaces” that the application developer provides to
get user configured personalization data.
(4) “Delivery Personalized Messages” via all the delivery methods
specified above or via additional methods of his choosing, using the
personalized message media file. Flags for delivery methods supported for
a particular Product (Products Table in the AG database or the like).

A developer registers in the AG database API table and obtains an authentication token for use of the API. The system counts the number of API calls the developer makes and is able to report on usage for the purpose of billing and analytics.

There are endpoint extensions in the API for the web application as well as content processing application 104. The API is housed and managed by a separate API server in the infrastructure.

The AG API can be accessed in a transactional manner or a batch manner accepting inputs and returning outputs in format of comma or delimited text files, XML, or JSON.

(13) Delivery of Personalized Message Based on Near Field Communication (NFC)

User configured or system configured personalized message delivery based on swiping a device with Near Field Communication (NFC) reader enabled and activated. NFC technology is disclosed in, for example, U.S. Patent Application Publication No. 2007/0265033 (Brostrom), titled “System and Method for Storing Near Field Communication Tags in an Electronic Phonebook,” which contents are incorporated by reference.

(13.1) User Configured Message

User sees point of purchase promotion at a retail store or other point of interest on a map or physical location. User swipes his NFC enabled device on an NFC tag. Tag maps to a URL which is mapped to a Product in the AG database 106. User inputs variables via social media application 102 allow or manual input of variables in a user interface form. Variables are passed to the AG API. Content processing application 104 produces a personalized message per process described above that is delivered to the user via the delivery methods described above.

(13.2) System Configured Message

User sees point of purchase promotion at a retail store or other point of interest on a map or physical location. User swipes his NFC enabled device on an NFC tag. Tag maps to a URL which is mapped to a Product in the AG database. Based on where the tag was scanned, associated variables are passed to the AG API. Content processing application 104 produces a personalized message per process described above that is delivered to the user via the delivery methods described above. The tag may also direct user to a URL where he can pick up a message that was personalized beforehand by API calls from a CRM system to the AG API. The user's device or NFC reader application identifier matches the user with the message that was made for him.

System can personalize the message by knowing that a user scanned an NFC tag in a certain place both facts can be used in the message, e.g. “I see you are using a Google phone with NFC” and “I see you are there at Starbucks in Beverly Hills, Calif.”

(14) Personalized eCards Based on User Personalization of Paper Greeting Cards

Software to take user configured personalization data that a sender provides on a paper greeting card as an input to a digital personalized message delivered to a recipient specified by the sender.

(14.1) User Configured Data Input

A sender of a paper greeting card purchased the greeting card. The greeting card contains a unique identifier numeric code or a QR code that represents a Product in the AG Database. Additional form input boxes are printed on the back of the card. The input boxes represent Positions in the Product script and the sender writes in the values with a writing implement on the card. There is also and input box for recipient's email address for delivery. The user downloads a third-party QR code or Optical Character Recognition (OCR) mobile or web application that makes use of the camera on his device. The scan takes the text input the sender has written into the input fields on the card and converts them into a digital string that is sent to the AG API. The input fields are matched to variables in a Product script and are matched to a media clip for each Position or matched to a default media clip, in the case of no match. API request with personalization parameters is sent to content processing application 104 to generate a personalized message.

(14.2) Recipient Pick-Up of the Personalized Message

Recipient gets personalized message via the delivery methods described above including email, social media wall post, etc.

(15) Personalized Internet Advertising

API methods to take input variables from ad networks or websites where ad networks server advertising and output a personalized message. There are methods for search advertising and display advertising.

(15.1) Search Advertising

Personalization of Product is initiated by user entry of search term into a search engine input box. Search terms plus other user data gathered in cookies are delivered to the AG API. The AG API returns a personalized message that is delivered to the ad server. Ad server creates a link to the personalized message and displays it to the user on the search results page where he entered his query.

(15.2) Display Advertising

Personalization of Product is initiated by user visit to a web page, mobile web page, web-based television show, mobile application or any other location where an internet advertising network owns or manages real estate for display ads. User data gathered in cookies (system generated data) or via user are delivered to the AG API. The AG API returns a personalized message that is delivered to the ad server. Ad server creates a link to the personalized message and displays it to the user on the search results page.

User Input on a rich media ad whereby an ad server passes the data from the user to the AG API containing personalization parameters for assembly of a message. An ad server passes the data from a user's session, via stored cookies, to the AG API containing personalization parameters for assembly of a message. Cookies can store behavioral data on the user, e.g., what pages the user visited and pass them to the ad server which in turn, passes them to the AG API. Cookies can also store registration information on a user gathered by the website the user is on. This is also known as “first party data.”

Ad networks who use data service providers to augment the information used to target internet display ads can also pass this user data to the AG API for the purposes of assembling a personalized message.

(16) System to Facilitate Personalized User Recorded Messages

Web-based software and API methods to allow any user with access to a web camera, Internet connectivity and editing software to script, record, upload to the CMS and deliver personalized messages.

(16.1) Scripting

Software to assist user in script template creation. Web-based wizard software takes user thru a step by step process of script template creation allowing users to add a Position, configure the Position type as static or variable, Position duration and assign script labels to the variables. End result is a web-based script template associated with a Product created in the AG database.

(16.2) Recording

With the assistance of a script template loaded into a web browser, user uses a web camera or digital camera to record media clips. User can edit the clips using computer based or online third-party software.

(16.3) Uploading

API methods to upload user generated clips to Product Positions. Returns a success or failure in the case that an asset is too long or short for a specific Position.

(16.4) Delivery

Software to build an interface for Product personalization by a recipient based on user configured or system configured data described above. Delivery of the personalized message via methods described in delivery of personalized media content process above.

The system provides a graphical user interface to create or update a Product via the Products Table. The Product Scripts table is also queried for each Position and user records via webcam or microphone or uploads from his computer all the required component media clips for each Position. These media clips are stored in the Audio Clips or Video Clips tables.

The Users Table in the AG database stores all personalization parameters related to the message.

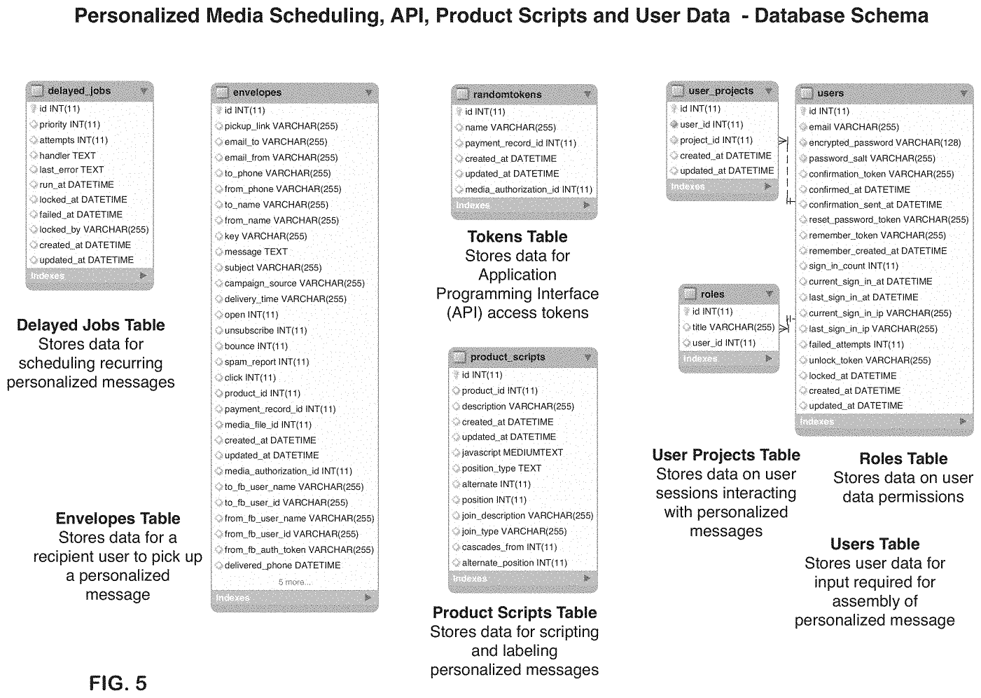

FIG. 5 is a graphical representation of a preferred embodiment database schema for personalized media scheduling, API, product scripts, and user data.

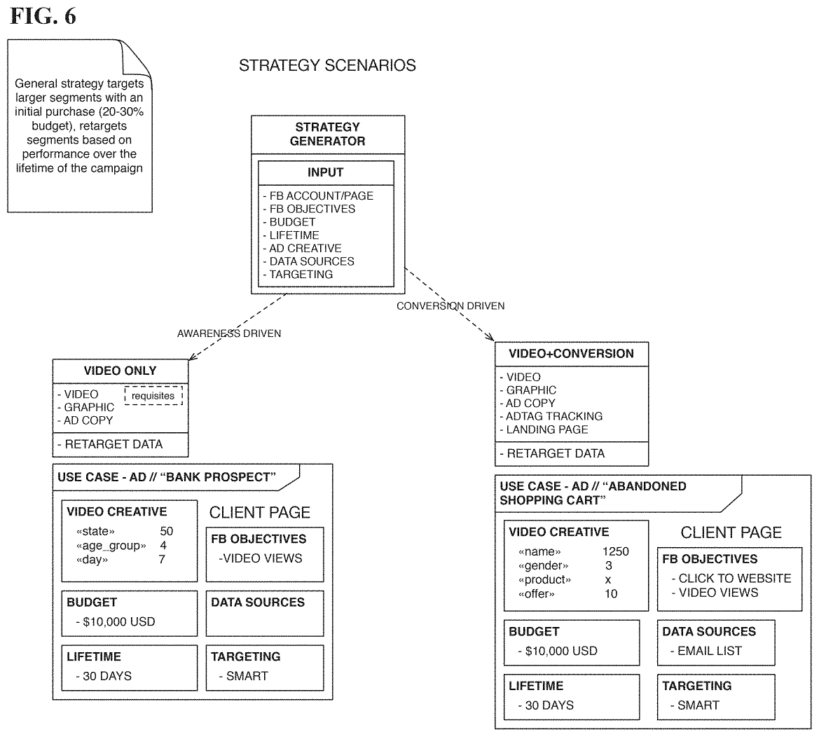

FIG. 6 describes a strategy generator which utilizes provided inputs—including targeting parameters, budgets and objectives—to recommend and create a deployment strategy which includes all recommended creative attributes (demographics, geo, devices, placements, etc.). The strategy generated is used to determine the most effective personalization.

Based on the platform selection, for example, if the input (objective) is Link Clicks a conversion-driven strategy will be created. Based on platform selections, media-types will be recommended.

With a brand-awareness objective a video engagement strategy will be created. Based on reach, impressions, CPM goals, geo-targeting and device placement breakdown may be recommended. Based on platform selections, media-types will be recommended (1:1, 16:9, 9:16 formats).

Based on the campaign objective and platform selections, a variety media-types will be recommended that may include rich-media HTML, carousels, quick-GIFS, videos, etc.

All strategy recommendations are omni-channel deployable and contain channel-specific targeting (demographic, geo, placements, media types) and creative attributes.

The strategy may consider previously generated strategies and their performance to recommend the most efficient/effective targeting and creative attributes for a particular campaign/objective.

The strategy generator considers all creatives and targeting attributes and then enumerates all ad targeting and creative schema appropriate for the given platform.

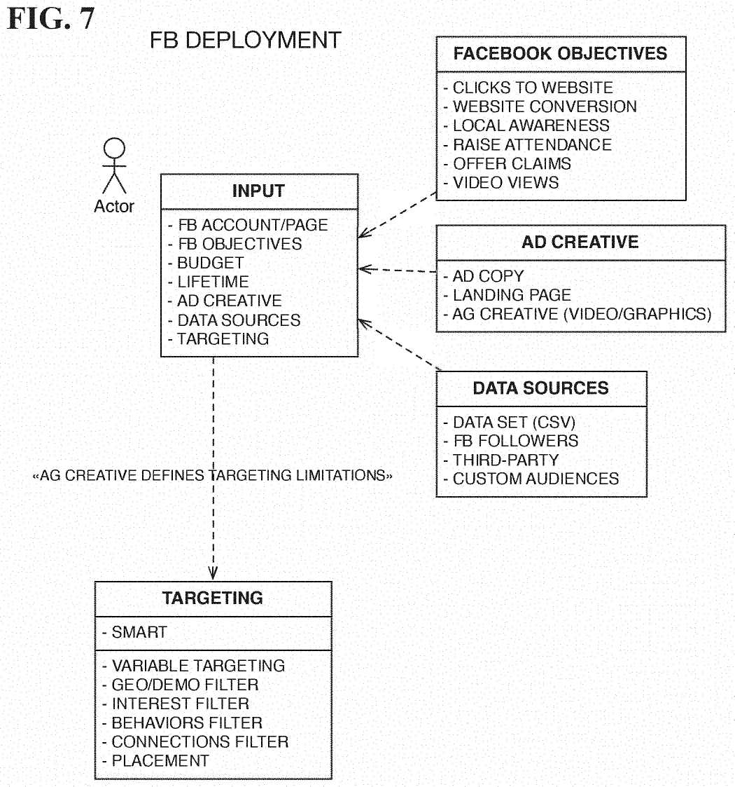

FIG. 7 describes a strategy generator which utilizes provided inputs—including targeting parameters, budgets and objectives—to recommend and create a deployment strategy which includes all personalized creatives mapped to an advertising platform's specific spec (e.g. a Walled Garden like Facebook). It contains the entire campaign/media plan tree.

All strategy recommendations for Facebook are programmatically enumerated to Facebook's specifications. This includes full campaign deployment and all sub-level ad objects. Based on the targeting recommendation and identified audiences, Ad Sets are created to spec (e.g. new visitors in California, recent shoppers in New York, etc.). All ad creative is deployed to its respective targeting spec (Ad Set).

### Summary of Various Embodiments

A1a. A computer implemented method for retailers, brands, manufacturers, service providers, and resellers to deliver personalized messages based on a script about their products to an end user, wherein end user data has been collected via at least one of (1) end user input, (2) a social media database containing user input, (3) a CRM database query based on end user information, (4) cookies and browser header from the end user net surfing, and (5) second and third party data providers, the computer implemented method comprising: a web application server accessing the end user data and storing on a local database; a media server retrieving the end user data from the local database, the media server containing a content management system having at least one product template that is defined by the script applicable to multiple products; the media server accessing a media file server containing media clips presenting a product and a position, and processing at least one media clip based on the product template from the content management system and the end user data to generate a personalized message; a content distribution network receiving the personalized message from the media server and relaying the personalized message to the web application server; and the web application server delivering the personalized message to the end user.

A1b. A computer implemented message delivery method, the method comprising: collecting user data about a recipient, wherein the user data is collected via: (1) recipient input, (2) a social media database, (3) a CRM database query based on recipient information, (4) cookies and browser header from the recipient net surfing, and/or (5) second and third-party data providers; a web application server storing the collected user data in a local database; a media server retrieving the collected user data from the local database, the media server containing a content management system having at least one product template defining a set of two or more positions; the media server accessing a media file server containing a set of two or more media clips associated with one of the positions in the product template, and selecting, based on the retrieved user data, at least one media clip from the set of media clips; generating a personalized message comprising the selected media clip; providing the personalized message to a content distribution network; the content distribution network relaying the personalized message to the web application server; and the web application server delivering the personalized message to the recipient.

A1c. A computer implemented message delivery method, the method comprising: collecting user data about a recipient, wherein the user data is collected via: (1) recipient input, (2) a social media database, (3) a CRM database query based on recipient information, (4) cookies and browser header from the recipient net surfing, and/or (5) second and third-party data providers; storing the collected user data in a local database; storing at a product template defining a set of two or more positions; retrieving the collected user data from the local database; accessing a media file server containing a set of two or more media clips associated with one of the positions in the product template; selecting, based on the retrieved user data, at least one media clip from the set of media clips; generating a personalized message comprising the selected media clip; and providing the personalized message to a content distribution network.

A2a. The method of embodiment A1b, further comprising: the content distribution network relaying the personalized message to a web application server; and the web application server delivering the personalized message to the recipient.

A2b. The method of embodiment A1a, A1b, or A1c, wherein the product template controls at least one of a timeline, a duration of a position, a total duration of the personalized message, and the component clips used to concatenate into a single personalized asset.

A3. The method of embodiment A1a, A1b, or A1c, wherein the product template is in the form of at least one of the following: ad unit, audio greeting, mobile alert or social media broadcast message, social media page welcome message, and CRM message.

A4. The method of embodiment A1a, A1b, or A1c, wherein the product template is encoded with a tag descriptive of a form of distribution and/or a position of the product.

A5. The method of embodiment A1a, A1b, or A1c, wherein the recipient via the media server accesses and edits the product (e.g., a composition of components (positions) used to generate a single personalized piece of asset.)

A6. The method of embodiment A1a, A1b, or A1c, wherein the media server includes a personalization stream (a stream of data containing relevant attributes to personalize against), and a sender provides identifiers to the system to be matched with the recipient's user data on the local database, and the stream and personalized message are processed so that the personalized message is delivered to the recipient at a designated location.

A7. The method of embodiment A1a, A1b, or A1c, wherein timing information specified by a recipient (e.g., information identifying a specific time of day (i.e., 7:00 AM) and/or information identifying a time interval) is stored in the local database, and the method further comprises the web application server delivering a personalized message to the recipient on a recurring basis based on the timing information and user data for the recipient.

A8. The method of embodiment A1a, A1b, or A1c, wherein the content management system inserts a promotional position (e.g., an advertisement) into the personalized message.

A9. The method of embodiment A1a, A1b, or A1c, wherein the local database is accessible to a third-party via one or more API calls, and the third-party is able to use an API call to modify a recipient's user data, create a personalized message for the recipient, and/or modify the personalized message.

A10. The method of embodiment A1a, A1b, or A1c, wherein the personalized message is accessed and edited by content management system based on information accumulated by the system including at least one of date, time, news, and weather.

A11. The method of embodiment A1a, A1b, or A1c, wherein the personalized message is accessed and modified by the recipient via at least one of QR code scan and social media website application.

A12. The method of embodiment A1a, A1b, or A1c, wherein a sender accesses the local database, the sender updates the local database with positions in the product script contained on a paper greeting card sent to the recipient, and the recipient via Optical Character Recognition and QR code triggers delivery of the personalized message.

A13. The method of embodiment A1a, A1b, or A1c, wherein the recipient's user data received from cookies and browser header from the recipient net surfing is combined with the recipient's user data in the local storage via API call, and the API call to the media server generates a personalized message.

A14. The method of embodiment A1a, A1b, or A1c, wherein the client accesses at least one of an internet connectivity, and editing software, to script, record, and upload to the content management system to at least one of adding a new position and modifying the position.

A15. The method of embodiment A1a, A1b, or A1c, wherein the recipient uses at least one of iFrame and a widget to generate an API call to at least one of adding to and modifying the recipient's user data contained in the local storage.

A16. The method of embodiment A1a, A1b, or A1c, wherein the web application server delivers the personalized message to the recipient via at least one of the following distribution mechanisms: an outbound telephone call, a social media application, a website, a microsite, an email message, a mobile application, wireless digital signage, Near Field Communication, and a QR code.

A17. The method of embodiment A16, wherein the media server encodes at least one media clip to produce multiple formats of a personalized message, wherein the formats include at least one of hi definition video, a mobile device compatible, and computer executable.

A18. The method of embodiment A1a A1b, or A16, wherein a mobile application resident on a recipient's mobile device receives and plays the personalized message.

A19. A computer implemented method for advertisers to deliver personalized messages based on a script about their products to a recipient, wherein recipient's user data has been collected via (1) recipient input, (2) a social media database containing user input, (3) a CRM database query based on recipient information, (4) cookies and browser header from the recipient net surfing, and/or (5) second and third-party data providers, the computer implemented method comprising: a web application server accessing the recipient's user data, the recipient's user data including at least one of a purchase promotion, a map location, a physical location; storing the recipient's user data on a local database; a media server retrieving the recipient's user data from the local database, the media server containing a content management system having at least one product template that is defined by the script applicable to multiple products; the media server accessing a media file server containing media clips presenting a product and a position, and processing at least one media clip based on the product template from the content management system and the recipient's user data to generate a personalized message; a content distribution network receiving the personalized message from the media server and relaying the personalized message to the web application server; and the web application server delivers the personalized message to the recipient.

Various modifications may be made to the present invention without departing from the scope thereof. Although individual features of embodiments of the present invention may be shown or described in some of the drawings or discussions, respectively, and not in others, those skilled in the art will recognize that individual features of one embodiment of the invention can be combined with any or all of the features of another embodiment.

Accordingly, while various embodiments of the present disclosure are described herein, it should be understood that they have been presented by way of example only, and not limitation. Thus, the breadth and scope of the present disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are described as a sequence of steps, this was done solely for the sake of illustration. Accordingly, it is contemplated that some steps may be added, some steps may be omitted, the order of the steps may be re-arranged, and some steps may be performed in parallel.

1. A computer implemented message delivery method, the method comprising:
collecting user data about a recipient, wherein the user data is collected via: (1) recipient input, (2) a social media database, (3) a CRM database query based on recipient information, (4) cookies and browser header from the recipient net surfing, and/or (5) second and third-party data providers;
storing the collected user data in a local database;
storing at a product template defining a set of two or more positions;
retrieving the collected user data from the local database;
accessing a media file server containing a set of two or more media clips associated with one of the positions in the product template;
selecting, based on the retrieved user data, at least one media clip from the set of media clips;
generating a personalized message comprising the selected media clip; and
providing the personalized message to a content distribution network.

2. The method of claim 1, wherein the product template controls at least one of a timeline, a duration of a position, a total duration of the personalized message, and the component clips used to concatenate into a single personalized asset.

3. The method of claim 1, wherein the product template is in the form of at least one of the following: ad unit, audio greeting, mobile alert or social media broadcast message, social media page welcome message, and CRM message.

4. The method of claim 1, wherein the product template is encoded with a tag descriptive of a form of distribution and/or a position of the product.

5. The method of claim 1, wherein the recipient via the media server accesses and edits the product.

6. The method of claim 1, wherein the media server includes a personalization stream, and a sender provides identifiers to the system to be matched with the recipient's user data on the local database, and the stream and personalized message are processed so that the personalized message is delivered to the recipient at a designated location.

7. The method of claim 1, wherein
timing information specified by a recipient is stored in the local database, and
the method further comprises the web application server delivering a personalized message to the recipient on a recurring basis based on the timing information and user data for the recipient.

8. The method of claim 1, wherein the content management system inserts a promotional position into the personalized message.

9. The method of claim 1, wherein
the local database is accessible to a third-party via one or more API calls, and
the third-party is able to use an API call to modify a recipient's user data, create a personalized message for the recipient, and/or modify the personalized message.

10. The method of claim 1, wherein the personalized message is accessed and edited by content management system based on information accumulated by the system including at least one of date, time, news, and weather.

11. The method of claim 1, wherein the personalized message is accessed and modified by the recipient via at least one of QR code scan and social media website application.

12. The method of claim 1, wherein a sender accesses the local database, the sender updates the local database with positions in the product script contained on a paper greeting card sent to the recipient, and the recipient via Optical Character Recognition and QR code triggers delivery of the personalized message.

13. The method of claim 1, wherein the recipient's user data received from cookies and browser header from the recipient net surfing is combined with the recipient's user data in the local storage via API call, and the API call to the media server generates a personalized message.

14. The method of claim 1, wherein the client accesses at least one of an internet connectivity, and editing software, to script, record, and upload to the content management system to at least one of adding a new position and modifying the position.

15. The method of claim 1, wherein the recipient uses at least one of iFrame and a widget to generate an API call to at least one of adding to and modifying the recipient's user data contained in the local storage.

16. The method of claim 1, wherein the web application server delivers the personalized message to the recipient via at least one of the following distribution mechanisms: an outbound telephone call, a social media application, a website, a microsite, an email message, a mobile application, wireless digital signage, Near Field Communication, and a QR code.

17. The method of claim 16, wherein the media server encodes at least one media clip to produce multiple formats of a personalized message, wherein the formats include at least one of hi definition video, a mobile device compatible, and computer executable.

18. The method of claim 1, wherein
a mobile application resident on a recipient's mobile device receives and plays the personalized message, and
the method further comprises:
the content distribution network relaying the personalized message to a web application server; and
the web application server delivering the personalized message to the recipient.

19. A computer implemented method for advertisers to deliver personalized messages based on a script about their products to a recipient, wherein recipient's user data has been collected via (1) recipient input, (2) a social media database containing user input, (3) a CRM database query based on recipient information, (4) cookies and browser header from the recipient net surfing, and/or (5) second and third-party data providers, the computer implemented method comprising:
a web application server accessing the recipient's user data, the recipient's user data including at least one of a purchase promotion, a map location, a physical location;
storing the recipient's user data on a local database;
a media server retrieving the recipient's user data from the local database, the media server containing a content management system having at least one product template that is defined by the script applicable to multiple products;
the media server accessing a media file server containing media clips presenting a product and a position, and processing at least one media clip based on the product template from the content management system and the recipient's user data to generate a personalized message;
a content distribution network receiving the personalized message from the media server and relaying the personalized message to the web application server; and
the web application server delivers the personalized message to the recipient.

20. A computer implemented message delivery method, the method comprising:
collecting user data about a recipient, wherein the user data is collected via: (1) recipient input, (2) a social media database, (3) a CRM database query based on recipient information, (4) cookies and browser header from the recipient net surfing, and/or (5) second and third-party data providers;
a web application server storing the collected user data in a local database;
a media server retrieving the collected user data from the local database, the media server containing a content management system having at least one product template defining a set of two or more positions;
the media server accessing a media file server containing a set of two or more media clips associated with one of the positions in the product template, and selecting, based on the retrieved user data, at least one media clip from the set of media clips;
generating a personalized message comprising the selected media clip;
providing the personalized message to a content distribution network;
the content distribution network relaying the personalized message to the web application server; and
the web application server delivering the personalized message to the recipient.
